(19) United States
(12) Patent Application Publication
(10) Pub. No.: US 2024/0171641 A1
(43) Pub. Date: May 23, 2024

(54) DATA SERVICE MANAGEMENT OF PROXY DEVICES

(71) Applicant: Connectify, Inc., Philadelphia, PA (US)

(72) Inventors: Brian Prodoehl, Plymouth Meeting, PA (US); Alexander Gizis, Philadelphia, PA (US); Kevin Cunningham, Swarthmore, PA (US)

(21) Appl. No.: 18/511,918

(22) Filed: Nov. 16, 2023

Related U.S. Application Data
(60) Provisional application No. 63/426,127, filed on Nov. 17, 2022.

(51) Int. Cl. H04L 67/141; H04L 12/46; H04L 67/56

(52) U.S. Cl. CPC H04L 67/141; H04L 12/4641; H04L 67/56

(57) ABSTRACT

One example may include receiving a data session request at a VPN server from a client device to establish a data session to receive data from a remote server, determining whether the data session request should be routed to one or more available proxy devices based on one or more of known attributes of the remote server and a data session requirement associated with the data session, selecting by the VPN server, one or more proxy devices to forward the data request to the remote server, and the one or more proxy devices are selected based on one or more data session requirements associated with the data session and receiving, at the VPN server, the data from the remote server by the one or more proxy devices, and forwarding, via the VPN server, the data to the client device.

### TECHNICAL FIELD

This application relates to a virtual private network (VPN) server and more particularly to managing proxy devices via the VPN server to assist with data management processes.

### BACKGROUND

Client devices may be identified as being at a particular source and location and having specific attributes, such as a hardware device profile, an assigned IP address, an assigned network, etc. The use of client devices to perform various data access operations can be prohibited or at least limited by the settings and restrictions of the remote sources that are being accessed by the client devices. For example, a client device may be attempting to access a secure and popular server for secure information, such as streaming content, secure order information, access to a protected account, etc.

A virtual private network (VPN) server is a tool that can offer an alternative to a client device's normal network data traffic. Generally, a VPN server may use different network routes and perform encryption among other data management operations. However, a VPN can become a suspected source of data abuse or unwanted traffic by a remote server. The result may include blocking, by the remote server, the VPN server from continuing to provide data management services. The client device may, in turn, be blocked from accessing a particular site. The source of data requests can be identified and screened by the remote servers and this may lead to limited data access to certain data sites over the Internet.

Browsing the web privately, or using VPN technology, such as the VPN server, to achieve faster, more reliable connectivity, involves utilizing an intermediate server. This intermediate server is often detected as a ‘VPN server’, for various reasons, such as but not limited to a registered organization/Internet service provider (ISP) and network peering, which may determine whether a next data hop is from a known datacenter or not, and whether there is a record of previous behavior from a particular known device or network location/address. In an attempt to avoid such identifiability, a service provider can rent IP addresses and identify its devices as a new organization, such IP addresses may be from a known carrier. Another approach is to let the client device bypass specific domains/IP addresses/applications, etc., and/or forward all or some web traffic through a proxy device service.

### SUMMARY

One example embodiment may include a process that includes receiving a data session request at a VPN server from a client device to establish a data session to receive data from a remote server, determining whether the data session request should be routed to one or more available proxy devices based on one or more of known attributes of the remote server and a data session requirement associated with the data session, selecting by the VPN server, one or more proxy devices to forward the data request to the remote server, and the one or more proxy devices are selected based on one or more data session requirements associated with the data session and receiving, at the VPN server, the data from the remote server by the one or more proxy devices, and forwarding, via the VPN server, the data to the client device.

Another example embodiment may include a receiver configured to receive a data session request from a client device to establish a data session to receive data from a remote server, and a processor configured to determine whether the data session request should be routed to one or more available proxy devices based on one or more of known attributes of the remote server and a data session requirement associated with the data session, select one or more proxy devices to forward the data request to the remote server, and the one or more proxy devices are selected based on one or more data session requirements associated with the data session, receive the data from the remote server by the one or more proxy devices, and forward the data to the client device.

### BRIEF DESCRIPTION OF THE DRAWINGS

FIG. 1 illustrates a communication network used to support data management of client devices according to example embodiments.

FIG. 2A illustrates an example network of a client device communicating with a remote server via a VPN server by using one or more proxy devices according to example embodiments.

FIG. 2B illustrates an example network of a client device communicating with a remote server via a VPN server by using multiple proxy devices according to example embodiments.

FIG. 2C illustrates an example network of client devices communicating with a remote server via a VPN server by using different respective proxy devices according to example embodiments.

FIG. 2D illustrates an example network of client devices communicating with a remote server via a VPN server by using a same proxy device according to example embodiments.

FIG. 2E illustrates an example network of client devices communicating with a remote server via a VPN server by using different proxy devices and one client device also using a non-proxy data route according to example embodiments.

FIG. 2F illustrates an example network of client devices communicating with a remote server via a VPN server by using a browser based data sharing application according to example embodiments.

FIG. 3A illustrates a flow diagram of an example process of using a proxy device for data management according to example embodiments.

FIG. 3B illustrates a flow diagram of an example process of using a proxy device for data management according to example embodiments.

FIG. 3C illustrates a flow diagram of an example process of using a proxy device for data management according to example embodiments.

FIG. 3D illustrates a flow diagram of an example process of using a proxy device for data management according to example embodiments.

FIG. 4 illustrates a system configuration for storing and executing instructions for any of the example processes according to example embodiments.

### DETAILED DESCRIPTION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments provide data management services for client devices participating in a shared data network configuration. Data may be sent and received to and from a remote network and shared between the devices to provide a larger data rate and an optimized data connection.

Example embodiments may be referred to with reference to a communication ‘session’. The term ‘session’ may be a communication data link between a ‘client’ (computing device, smartphone, computer, etc.) and ‘server’ (content server, virtual private network server, destination server, etc.) or any two or more network-based entities in communication across a data communication network. A session may be based on a single communication link or channel or multiple links or channels. Examples of multiple channels being used in a session may be based on multiple network interface devices (i.e., network interface cards (NICs)) being used in a single session, and/or multiple TCP/UDP sockets being created in a single session among other device resources. Multiple transport connections which are established via TCP and/or UDP may also be considered a session. Additionally, encryption that is used for the session may be independently established to include a unique key for each transport connection and/or channel established for the session. The session encryption may instead be a single key encryption used to encrypt all the communication exchanges during the session. In general, most transport connections are encrypted independently. All of the described examples of a session may be adapted to include one or more alternatives or combinations thereof. Each session may be subjected to multiple different communication mediums providing a variety of one or more channels, transports, radio links, physical links, network interface cards and wireless and/or wired connections.

Network connection optimization for an application server provides data network access through communication channels to one or more client devices. Data communication protocols may include one or more of a transmission control protocol (TCP) and/or a user datagram protocol (UDP). Also, the TCP/IP protocol suite enables the determination of how a specific device should be connected to the Internet and how data can be exchanged by enabling a virtual network when multiple network devices are connected. TCP/IP stands for transmission control protocol/Internet protocol and it is specifically designed as a model to offer reliable data byte streams over various interconnected data networks.

UDP is a datagram/packet oriented protocol used for broadcast and multicast types of network transmissions. The UDP protocol may work similar to TCP, but with some of the error-checking criteria removed which reduces the amount of back-and-forth communication and deliverability requirements.

TCP is a connection-oriented protocol and UDP is a connectionless protocol. The speeds (data rates) associated with TCP are generally slower than UDP, while the speed of UDP is generally faster within the network with regard to sending data across a network. TCP uses a ‘handshake’ protocol such as ‘SYN’, ‘SYN-ACK’, ‘ACK’, etc., while UDP uses no handshake protocols. TCP performs error checking and error recovery, and UDP performs error checking, but discards erroneous packets. TCP employs acknowledgment segments, but UDP does not have any acknowledgment segment.

A TCP connection is established with a three-way handshake, which is a process of initiating and acknowledging a connection. Once the connection is established, data transfer begins and when the transmission process is finished the connection is terminated by the closing of an established virtual circuit. UDP uses a simple transmission approach without implied hand-shaking requirements for ordering, reliability, or data integrity. UDP also disregards error checking and correction efforts to avoid the overhead of such processing efforts at the network interface level, and is also compatible with packet broadcasts and multicasting.

TCP reads data as streams of bytes, and the message is transmitted to segment boundaries. UDP messages contain packets that were sent one by one. It also checks for integrity at the arrival time. TCP messages move across the Internet from one computer to another. It is not connection-based, so one program can send lots of packets to another. TCP rearranges data packets in a specific order. UDP protocol has no fixed order because all the packets are independent of each other. The speed for TCP is slower and UDP is faster since error recovery is omitted from UDP. The header sizes are 20 bytes and 8 bytes for TCP and UDP, respectively.

In general, TCP requires three packets to set up a socket connection before any user data can be sent. UDP does not require three packets for socket setup. TCP performs error checking and also error recovery and UDP performs error checking, but discards erroneous packets. TCP is reliable as it guarantees delivery of data to the destination router. The delivery of data to the destination is not guaranteed by UDP. UDP is ideal to use with multimedia such as voice over IP (VoIP) since minimizing delays is critical. TCP sockets should be used when both the client and the server independently send packets and an occasional delay is acceptable. UDP should be used if both the client and the server separately send packets, and an occasional delay is not acceptable.

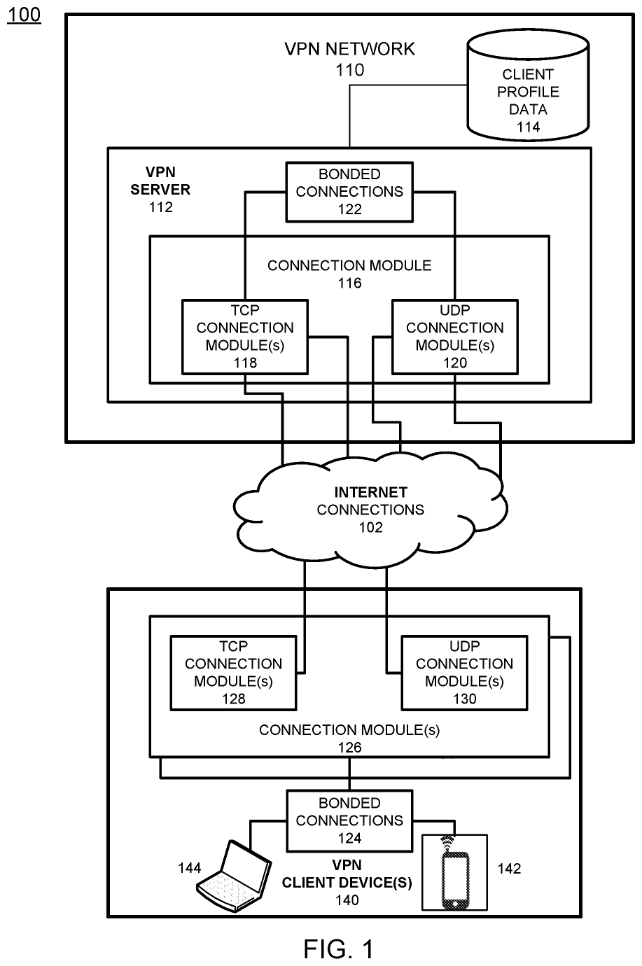

FIG. 1 illustrates an example data session network configuration according to example embodiments. Referring to FIG. 1, the configuration 100 may include a virtual private network (VPN) 110 which includes one or more VPN servers 112 and data storage, which in this case is used for storing at least client profile data 114 associated with one or more new or old client communication sessions. The term ‘VPN’ may represent one or more servers designated to perform the VPN functionality. The communication sessions may include multiple network channels, generally, UDP and TCP are used for such sessions, however, other protocols used across the Internet 102 may also be used, such as HTTPS. The channels may be bonded together to create a single virtual channel for communication as shown from the bonded connections module 122 for the VPN server 112 and the bonded connections module 124 of the client device 140. In general, the VPN 112 may include UDP module(s) 120 and a TCP module(s) 118 as part of a connection module 116 to manage the connection process and a bonded connections module 122 to manage the various channels and the bonding of information among the channels.

The client side may include one or more client devices 140 such as a smartphone 142, cell phone, tablet, laptop 144, etc. Any one of those individual devices may be the ‘client device’ 140 at any particular time for a particular session. The client side may have an installed agent software application that communicates with the cloud servers of the VPN network 110. The communications are established and maintained across the Internet 102. The client side may also have its own bonded connections module 124 which manages one or more TCP/UDP connections associated with TCP/UDP connection modules 128/130, each of which may have multiple modules to accommodate multiple session, as part of the connection module(s) 126 of the client side. The connection module 126 may be multiple modules which are used for multiple respective sessions with various end user devices 140.

In general, a transport connection is a connection between the VPN client and the VPN server over a particular network and/or Internet connection using a particular protocol, such as TCP, UDP, HTTPS, or another protocol. The established connection is used to send encapsulated and/or encrypted application packets between the client and the server. In one example embodiment, multiple transports connections are created for each session over the available networks and protocols. Conventionally, a VPN will create one transport connection over one network with one protocol per session. For example, given two networks to utilize, the data connection optimization application may create three transport connections (e.g., TCP, UDP, and HTTPS) over each network, for a total of six transport connections. Other combinations of connection types, numbers of connections, etc., may also be utilized.

A VPN may be used by any client device participating in a collaboration session (i.e., conference) with other client devices. One device among a plurality of devices may be using a VPN while others are not using any VPN. All of the devices may send data and receive data to and from an application server in a cloud network, however, one or more client devices may use a VPN server as an intermediate/third party device to assist with the data management of that particular client device. One strategy employed by a VPN may include channel management over a single session. For example, multiple channels may exist for a single client device and can be combined into a bonded channel (unique data is sent on more than one channel), a mirrored channel (the same data is sent on more than one channel) or a combination of both. The channel management activities may permit packets to be sent and received faster and/or with fewer errors depending on the strategy employed by the VPN server. The VPN server(s) may have an optimal Internet connection to the application servers in the cloud network, and may use certain fundamental routing strategies to optimize data traffic quality, the VPN could send video data first as prioritized data from certain client devices to the cloud servers as opposed to browser request data, e-mail data, and other types of Internet data. All of these data management strategies and others can be managed by a VPN specific application that is operating on the client devices while the conference or other collaboration application is being utilized. The VPN (client) application may be a background type of application that is not detectable by the user or other applications using Internet data services. The VPN server may also attempt to host its own conference assuming the VPN server offers an application that is managed locally by the VPN server so the client devices which are part of that VPN network can have the VPN server perform additional conference application functions.

A VPN server may also implement a proxy service to provide additional data management implementations. A proxy device may also be referred to as a ‘proxy endpoint’, which may be a device that includes a CPU and one or more Internet connections. Other criteria may include a device that is operating a tunneling application, a specialized proxy application and an Internet connection management application. For purposes of this example, a proxy may be a user device (e.g., laptop, smartphone, tablet, etc.) that is connected to a network and is operating an agent application or plug-in which may be a partner (compatible) application to a VPN server application. Users of the VPN server may enable a proxy feature, that provides the proxy service to the VPN server so the device becomes a candidate for providing a proxy service to the VPN on an as needed basis. This agreement to provide such a service may enable the client device to receive the VPN server service at a limited rate or for no extra cost. Ideally, the VPN would have participating proxy client devices in various locations throughout a geographical area and with different capabilities and different ISP providers among other features.

The proxy endpoint devices could vary in type and all examples are intended to be non-limiting examples. One example could be a small device with one or more USB ‘4G’ dongles, or it could be a single device containing a CPU and one or more 4G/5G/‘X’G radios built into the device, or it could be a larger rack-mounted device with many 4G/5G/‘X’G radios, or it could even be a device with just a single cable modem connection. A tunneling application could be used to establish a secure tunnel between the proxy endpoint and one or more VPN servers/gateways. End user client device web traffic may be sent over the secure tunnels, between the proxy endpoint and the VPN gateways. The proxy application may be used to ‘proxy’ the web traffic between the secure tunnel and the destination web service. The Internet connection management application manages the lifecycle of the Internet connection(s) available to the proxy endpoint, and interfaces with the proxy endpoint coordinator.

Each available Internet connection is a candidate for serving as a proxy channel to a different device, the proxy application may initiate a cycle that includes confirming the connection is online and has access to Internet sites, the device has an IP address, ideally a newly assigned IP address, the connectivity is operable, a connection type is operable, the ISP is operational, and that registration information associated with the IP address is operational, which can be performed by checking with an online address database. Other operations may include checking a reputation of the IP address, such as by consulting a reputation database to confirm the IP address status, and performing active checks of services to see what is permitted and what is not permitted by the device. Still other operations may include checking Internet speed and other performance characteristics of the connection, and once all the information is gathered, if minimum acceptable thresholds of operation are confirmed (e.g., Internet data rate speeds, jitter, latency, etc.) then the device can be registered with a proxy endpoint coordinator agent of the VPN server. This may be performed autonomously based on the results of the information gathered being considered acceptable based on previously identified thresholds and rules. The proxy endpoint will then be an active candidate for proxy data services for a certain period of time prior to having to reestablish its credentials with the proxy coordinator. In the event that the minimum acceptable threshold(s) is not confirmed, the identified issues may be registered with the proxy endpoint coordinator, logged in memory and a period of time may be waited prior to transitioning back to the beginning of the initiation stage for a particular proxy candidate.

Once a proxy device is active, web traffic may be sent from the proxy device via the secure tunnel to the Internet connection for a period of time, a number of attempts/times (e.g., sessions) to a number of different servers, a number of times to a same server, and after some variable amount of time (e.g., 1 minute, 10 minutes, 1 hour, 8 hours, 24 hours, etc.), the proxy may be transitioned to a ‘cool-down’ stage where there is no further data sent pending a release and IP renewal process. The cool-down stage may include waiting for proxied web traffic connections to end in an attempt to not interrupt customer web sessions. The cool-down period may be mandatory for an hour or some other period of time prior to re-establishing the proxy device as an active proxy. Then, the proxy may be transitioned back to a warm-up stage to re-initiate itself as a candidate for proxy services.

The proxy endpoint coordinator (i.e., VPN server) may listen for advertisements and status updates from proxy endpoints, and share that information with VPN gateways that may want to use those proxies to assist other client devices. Information gathered from the proxy endpoints might include how to establish a secure tunnel to the proxy endpoint, protocols used or supported, a public key to access the proxy, an address to identify the proxy, a port used by the proxy, proxy channel information, a connection type, an ISP name, data rates, current statistics for data, including latency, jitter, speeds, a geo-location (e.g., country, estimated latitude/longitude, etc.), a status (e.g., active, cooling down, warming up, etc.). The VPN gateway/server may query the proxy endpoint coordinator for information about what proxy endpoints are available, establish a secure tunnel to the one or more proxy endpoints, and forward applicable web traffic to a proxy channel. The transport connection between the proxy endpoint and the VPN gateway may require certain considerations, such as whether the proxy is operating a secure connection, since the proxy endpoint side will almost always be behind a network address translation (NAT), the VPN gateway side is publicly accessible and the initiating side will need to act as a proxy server.

Criteria for a proxy selection begins with the client device requesting access to a particular site. The request can be answered by a proxy service managed by a VPN server or by a VPN server that does not use a proxy service/proxy device. The physical/geographical location of the proxy device may also be important criteria for the selection process. The networking and data management settings of the proxy would need to meet or exceed the settings used by the client device in order to be proficient.

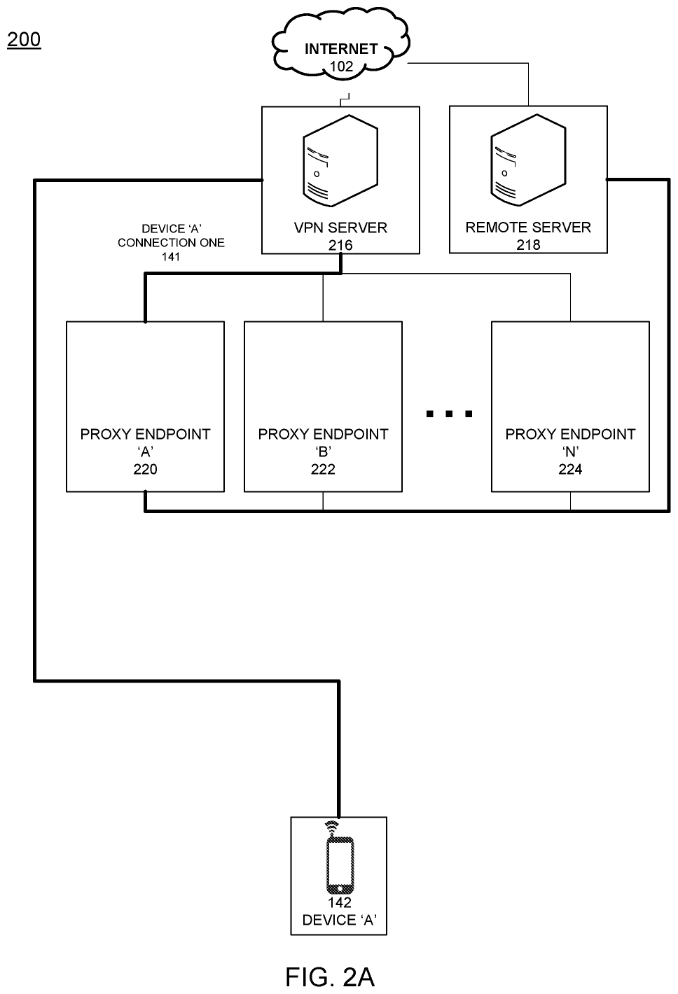

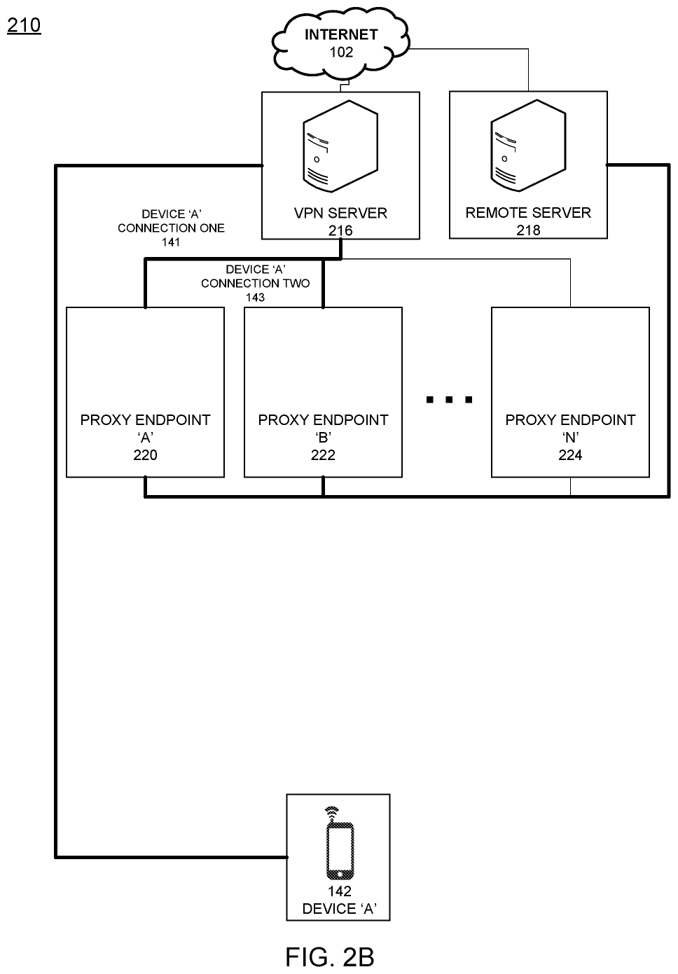

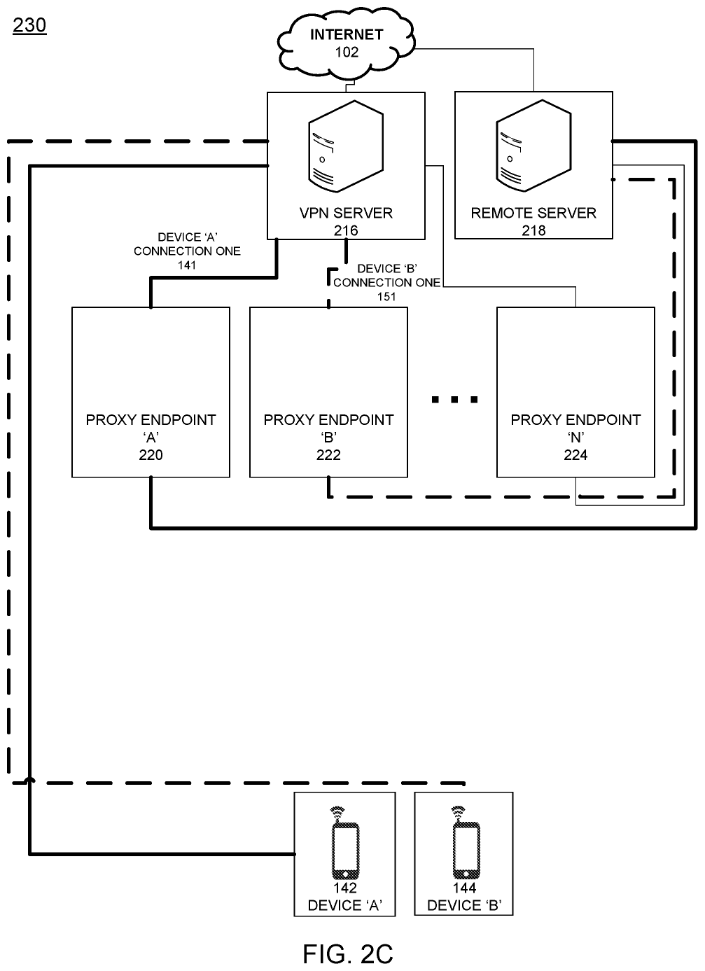

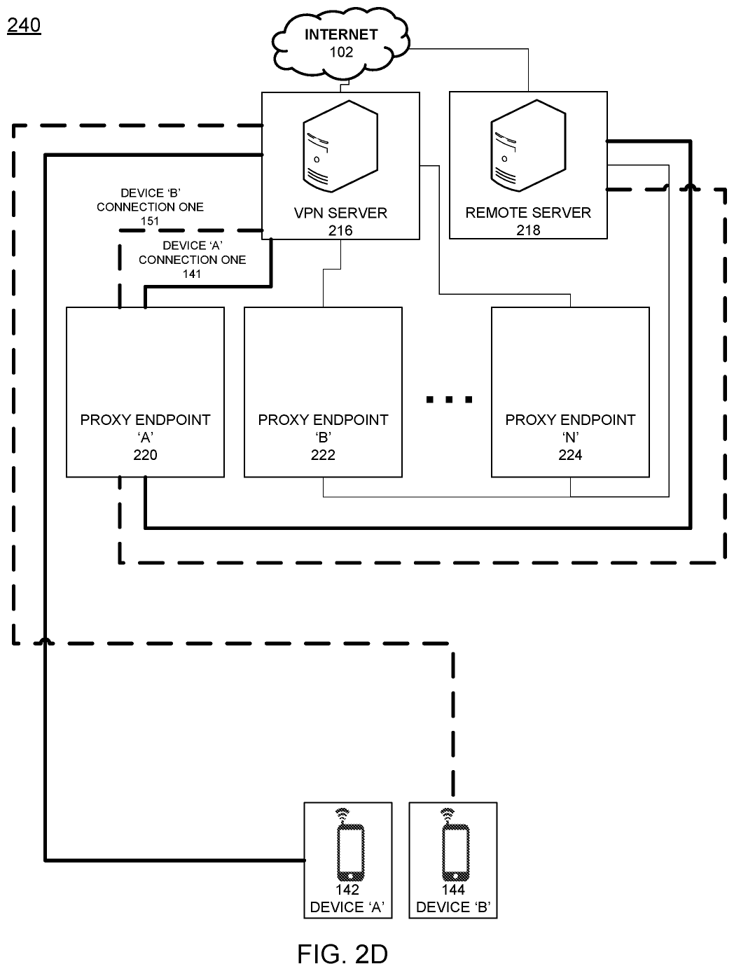

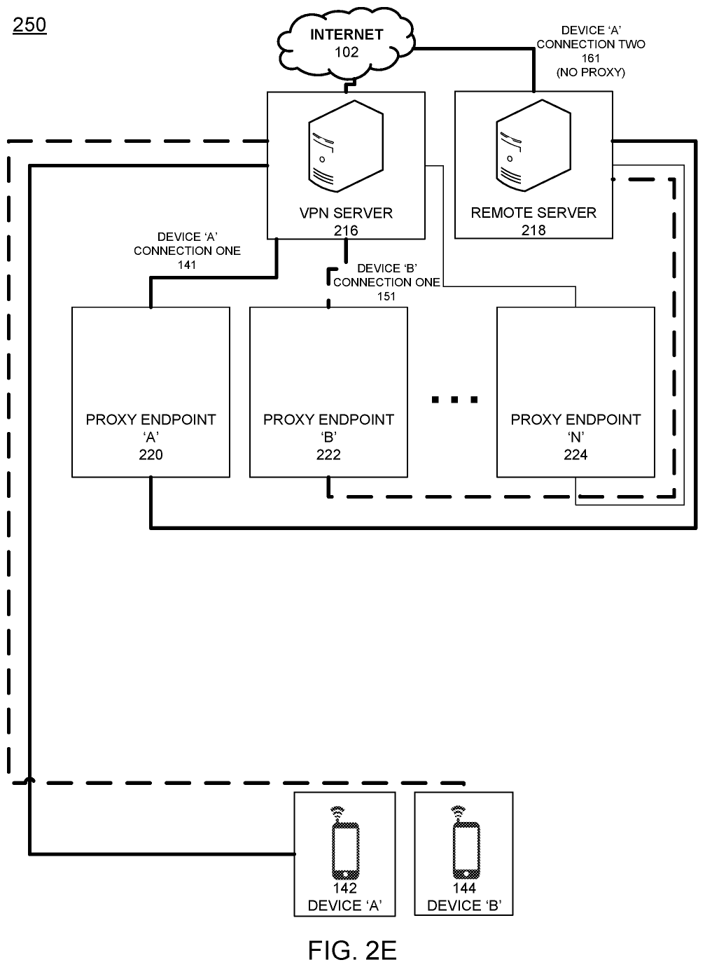

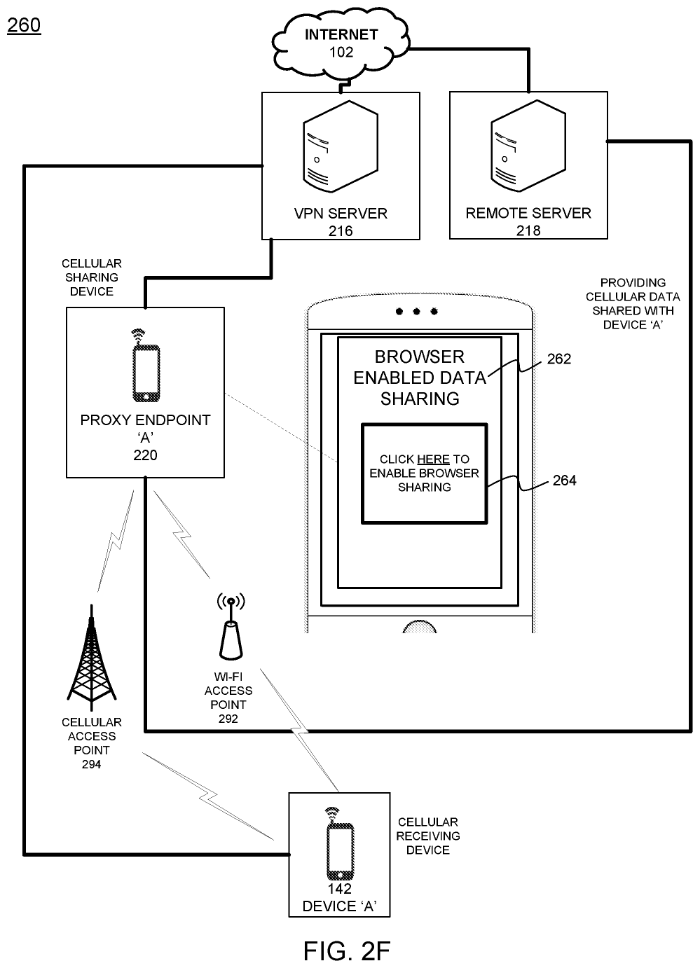

FIG. 2A illustrates an example network of a client device communicating with a remote server via a VPN server by using one or more proxy devices according to example embodiments. Referring to FIG. 2A, the configuration 200 includes a client device 142, such as a smartphone or other computing device, which is attempting to access a website, application, etc., that requires access to a remote server 218. The server may be one server or multiple servers and may include multiple different remote sites which can provide data to the client device 142. The data management process includes a VPN server 216 which is responsible for routing the client device data request to the remote server 218. A pool of proxy devices 220, 222 . . . 224, may be available at any time to provide a unique route, IP address, port assignment, location, etc., and/or any attribute a proxy device can provide as a data management service for routing data requests and data traffic to and from the client device 142 using the proxy device(s). The proxy devices 220-224 may be registered devices which are in communication with the VPN server 216 and which may have an incentive to route data traffic on behalf of the client device 142 in exchange for a VPN service. In this example of FIG. 2A, the client device 142 is using a first proxy device ‘A’ 220 to provide a single session or a single connection 141 to a remote server 218.

The reason for the VPN server 216 selecting the proxy device 220 as the candidate may include the proxy 220 having a particular physical location, IP address, port assignment, certain threshold data traffic characteristics (under a particular data threshold) over a period of time, and/or a protocol service that matches the data request from the client device 142, etc. Generally, the proxy 220 assignment will be temporary and may only permit a certain amount of data (e.g., 1 GB) and/or a certain amount of time as a data proxy for the client device 142. Once the session is completed, the proxy 220 may be released from use and may re-enter the pool of available proxy devices. During the proxy session, the proxy endpoint will be the source and destination for data traffic being received and sent to the client device 142. The client device 142 may use non-proxy data routes across the Internet concurrent with the proxy device 220 data service to provided added data connectivity. The client device 142 may also use additional proxies for the same server destination, for different server destinations, and for other data sessions to support other data applications. Also, the client device 142 may be using a cellular data service, a Wi-Fi data service of a nearby Wi-Fi access point, and/or other data services, such as a plug-in data source, a tethered device, or any combination thereof. In this example, the IP address of proxy endpoint 220 may enable an access operation to the remote server 218 which may be unavailable for the client device 142 at a particular time. The data connection by proxy endpoint 220 to the remote server 218 may be optimal and may have more data access (larger bandwidth, data rate, etc.) to the remote server 218 than if the client device 142 connected to the server 218 directly via its own Internet connection regardless of whether the VPN server 216 is being used or not.

FIG. 2B illustrates an example network of a client device communicating with a remote server via a VPN server by using multiple proxy devices according to example embodiments. Referring to FIG. 2B, the example configuration 210 demonstrates how one client device 142 may have requested data from a remote server 218 and may have been assigned multiple proxies to complete the data exchange between the remote server 218 and the client device 142. The VPN server 216 may select two proxies 220 and 222 as candidates to forward and receive data to and from the server 218. The first connection 141 may be for a primary data session and/or a first channel with a remote server 218 and the second connection 143 may be for a secondary data session and/or a second channel. The data may be split between the two sessions (bonded channels), such as in the case of buffering data from a streaming server providing audio/video to the client device 142. In this example, the bonded data may be for a packet stream that is divided between the two channels as a single logical channel source of data. Another scenario may be a non-overlapping data exchange where data is provided (transmitted and received) on the first connection 141 of the first proxy 220 for a period of time (e.g., 30 seconds) and then data is provided on the second connection 143 over the second proxy 222 for a period of time (e.g., 30 seconds) and then alternated back and forth until the session is completed. Another approach is to bond the two proxy data sessions by the VPN server 216 to increase the overall data throughput (data rate) and to reduce undesired data attributes, such as jitter, latency and related data network characteristics. Another approach may be to mirror the data exchange so the same data packets are sent to and from the remote server 218 over both proxies 220 and 222. The VPN server 216 can then discard any duplicated data that is received prior to forwarding the data to the client device. The VPN server 216 may manage the channel selection and bonding/mirroring performed for the data being sent to and from the client device 142 via the proxy data connections.

FIG. 2C illustrates an example network of client devices communicating with a remote server via a VPN server by using different respective proxy devices according to example embodiments. Referring to FIG. 2C, the example 230 includes a first client device 142 forwarding a data request for data from a remote server 218 and being assigned a proxy 220 for its session data exchange with the remote server 218. A second client device 144 may request data from the same server 218 or another server (not shown) and receive a data assignment to a different proxy 222. The connection 151 for the second client device 144 may be managed by the VPN server 216 to use the second proxy 222 to communicate with the server 218 while the first client device is using the first proxy 220 for its data connection 141 to the remote server.

FIG. 2D illustrates an example network of client devices communicating with a remote server via a VPN server by using a same proxy device according to example embodiments. Referring to FIG. 2D, the example 230 includes both client devices 142 and 144 using a single proxy device 220 for both respective data connections 141/151 to a remote server(s) 218. A proxy device may have more data management capabilities than other proxy devices, based on its data connection to a cellular service provider, a Wi-Fi access point, or a combination of both data access services. The proxy endpoint 220 may use channel bonding managed by the VPN server 216 so its cellular data and its Wi-Fi data are used simultaneously to provide a larger data throughput for the devices 142/144. One device 142 may be using the cellular data of the proxy device 220 and the other client device 144 may be using the Wi-Fi data of the proxy device 220. Alternatively, both client devices 142/144 may be sharing both data connections at the same time. For example, a client device 142 may only have access to cellular data which may have a restriction on access to the remote server 218. The VPN server 216 may identify a failure to connect to the remote server 218 by the client device 142 and may attempt to connect device 142 with proxy 220 to use the proxy device Wi-Fi data service to receive data from the remote server 218. The VPN server can then forward the data received by the proxy device 220 to the client device 142 over the cellular connection used by the client device 142 even though the server 218 provided the data to the proxy device 220, and in turn, the VPN server 216 over a Wi-Fi connection used by the proxy device 220. The IP addresses of the client devices 142, 144, the VPN server 216 and the proxy devices 220-224 may be unique. The locations of all of the devices may also be unique. The possibilities for borrowing a data communication path from one device and sharing it with another become increasingly numerous and provide more options when a connection is restricted, times-out or does not yield any data for the requesting device. The VPN server 216 may maintain records of each device 142/144 and which connection they are using at a given time.

FIG. 2E illustrates an example network of client devices communicating with a remote server via a VPN server by using different proxy devices and one client device also using a non-proxy data route according to example embodiments. Referring to FIG. 2E, the example 250 demonstrates how one or more client devices, in this case client device 142, may be using a proxy for a particular data session 141 and no proxy device for another data session or a second data session 161 which may be to a different server (not shown) or the same server 161. When a proxy is used for a communication session attempt and no proxy is used for another communication session attempt, whichever connection attempt works and provides access authorization and data exchanged, then that successful session can be the active session and the other session can be ignored. The failure to connect and receive data can be recognized by repeated attempts which may not include a certain threshold amount of data received by a client device. A first attempt to connect with a remote server 218 by a client device 214 may be provided without the proxy device via connection 161. A second attempt can be provided with the proxy device for another connection 141. Any subsequent attempts by the same client device 142 to the same server 218 may be provided by another proxy 222, and so on, until a data session is established. In this example, the client device ‘A’ 142 attempted to connect 141 with the remote server 218 via a proxy 220 and without a proxy via connection 161. Client device ‘B’ 144 attempted to connect to the server 218 via a single connection attempt 151. The number of connection attempts may be one, two or more depending on the success of the connection managed by the VPN server 216. Criteria for switching from a direct connection to a first proxy, second proxy, etc., may be based on failed attempts, past success, current success, etc. The VPN server 216 may maintain a record of each client device's connections and attempts to form a connection. The proxy devices 220-224 may be a registered list of devices which are available to assist based on recent registration data as available proxies vs. unavailable proxies. The proxy devices may receive an incentive to perform the proxy assistance to the registered client devices.

FIG. 2F illustrates an example network of client devices communicating with a remote server via a VPN server by using a browser based data sharing application according to example embodiments. Referring to FIG. 2F, the example 260 includes a client device 142 attempting to use a proxy endpoint 220 as a data source directly via the data services used by the proxy device 220. The access may be enabled by a browser based communication session on the device 220. The browser 262 may enable a link or automated sharing option 264 that is enabled when the client device 142 transmits a request to access the proxy device 220. The devices may be operating on a same Wi-Fi connection 292 or may be communicating over separate cellular connections 294 to a same or different cellular network. Alternatively, the proxy endpoint 220 may be on a Wi-Fi connection and the device 142 may be on a cellular connection 294 or vice versa.

When there is no common Wi-Fi network between client device ‘A’ and proxy endpoint ‘A’ 220, then communication will go through a ‘hop’ further out on the Internet, as determined by an interactive connectivity establishment (ICE) protocol. This may be through an upstream router on the same general network, if the devices are on different Wi-Fi networks that are both part of a larger common network. An example of this is if both devices are in the same hotel, and device ‘A’ is on the “main hotel” network, and proxy endpoint ‘A’ is on the “Guest” network, then they may be able to establish a connection through a shared router upstream of those different Wi-Fi networks, without needing to actually traverse a portion of the Internet network. If such a connection cannot be established, the devices will need to establish a connection through a hop further out on the Internet, either through their respective Internet service providers (ISPs), and if that is not possible, then through a relay server. When there is a common Wi-Fi between the client devices, then they can establish a direct connection over the wireless LAN and communicate directly through their local access point. This example would be ideal if device ‘A’ is attempting to connect to the Internet through proxy device ‘A’, via a browser based application for Internet data sharing from the proxy endpoint 220 to the device ‘A’ 142.

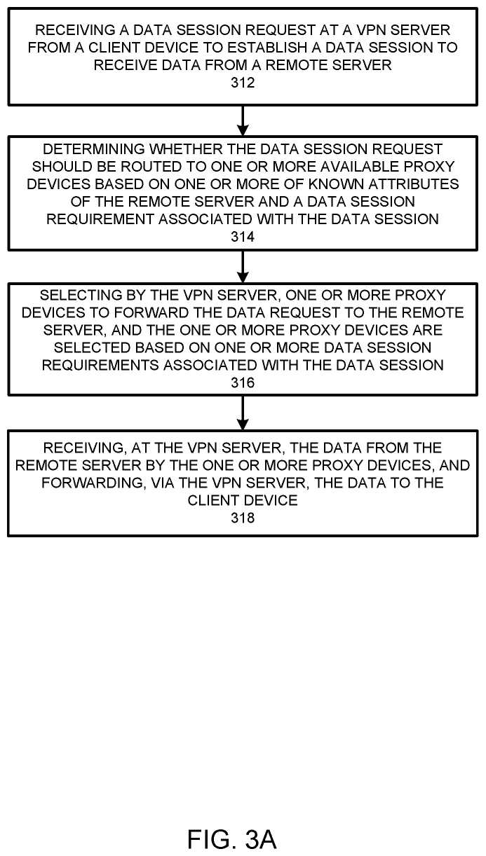

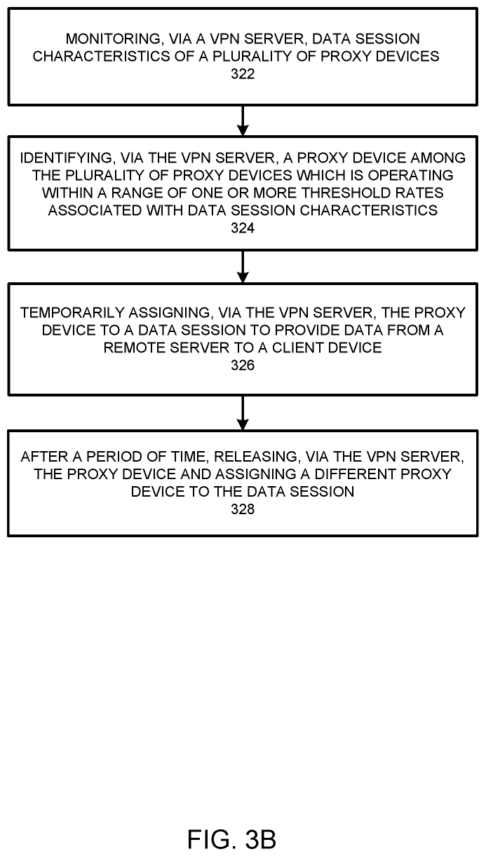

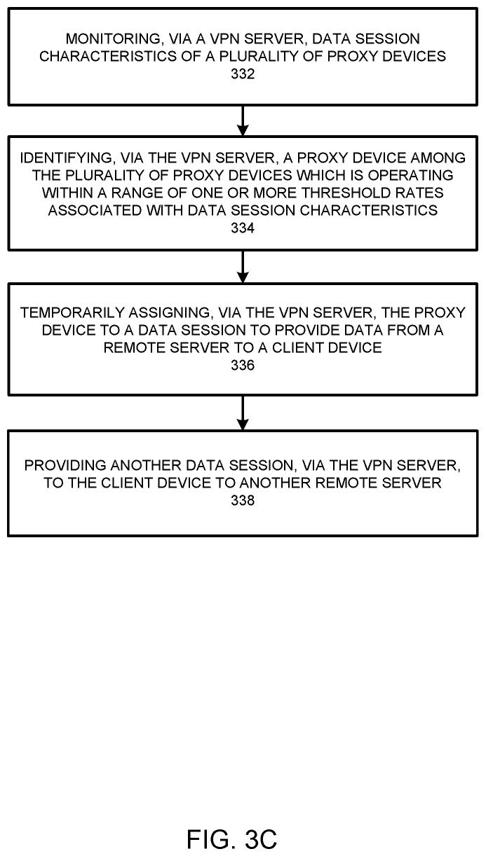

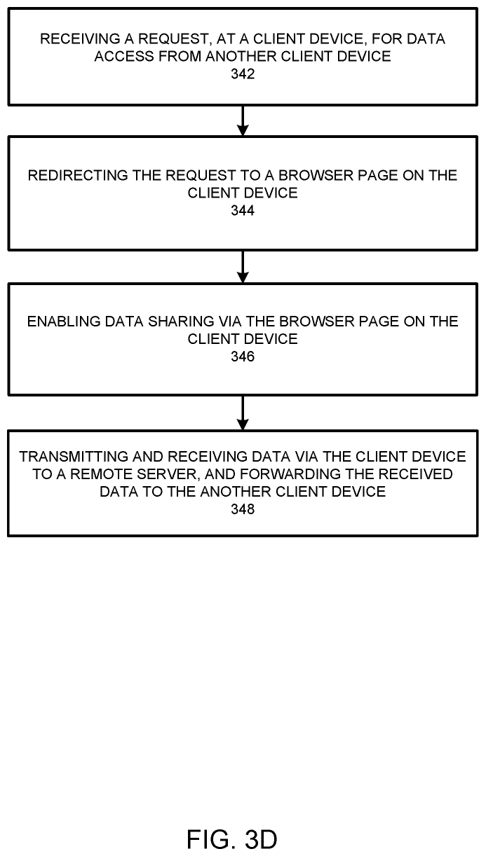

FIG. 3A illustrates a flow diagram of an example process of using a proxy device for data management according to example embodiments. Referring to FIG. 3A, an example method of operation may include receiving a data session request at a VPN server from a client device to establish a data session to receive data from a remote server 312, determining whether the data session request should be routed to one or more available proxy devices based on one or more of known attributes of the remote server and a data session requirement associated with the data session 314, selecting by the VPN server, one or more proxy devices to forward the data request to the remote server, and the one or more proxy devices are selected based on one or more data session requirements associated with the data session 316, and receiving, at the VPN server, the data from the remote server by the one or more proxy devices, and forwarding, via the VPN server, the data to the client device 318.

A request for data will inherently include an IP address or a domain name as a destination. The IP address can be resolved by a DNS lookup operation. A DNS server may provide a known web address which can be added to a list of sites which should be assigned a proxy device by the VPN server. The list may be stored and maintained by the VPN server. Also, the client device request for data may be identified to determine where it is going and which server is being identified. The IP address information is generally known, if the DNS information is encrypted the content of the data request and the IP address of the data request can still be identified along with application information, certificate information, and other information, such as the application, the original request, etc., this provides a way to determine where the data is going and whether to use a proxy device or no proxy device to route the data request. As the IP address is resolved with a domain name by a DNS server, the knowledgebase could be expanded to add the domain name to a particular list by the DNS server.

The process may also include selecting the one or more proxy devices by selecting the one or more proxy devices which are located closest to the remote server. The data session requirements may include one or more of threshold rates including one or more of a data rate, a jitter rate and a latency rate. The process may also include monitoring, via the VPN, the one or more proxy devices for a period of time, identifying a proxy device which is operating within an acceptable range of the one or more threshold rates, and assigning the proxy device to the data session. The assigning the proxy device may also include assigning the proxy device to the data session for a limited period of time. After the period of time, the process may include assigning a different proxy device to the data session. The process may also include detecting the data session has ended, and assigning a different proxy device to a next data session request.

FIG. 3B illustrates a flow diagram of an example process of using a proxy device for data management according to example embodiments. Referring to FIG. 3B, the method may include monitoring, via a VPN server, data session characteristics of a plurality of proxy devices 322, identifying, via the VPN server, a proxy device among the plurality of proxy devices which is operating within a range of one or more threshold rates associated with data session characteristics 324, temporarily assigning, via the VPN server, the proxy device to a data session to provide data from a remote server to a client device, and after a period of time 326, and releasing, via the VPN server, the proxy device and assigning a different proxy device to the data session 328. If a particular data session is exceeding a predetermined time frame and/or amount of data being used then the data session may be revoked on a particular proxy in favor of re-establishing the data session with no proxy, on a different proxy, etc. The process may also include assigning another data session of the client device to another proxy device.

FIG. 3C illustrates a flow diagram of an example process of using a proxy device for data management according to example embodiments. Referring to FIG. 3C, another example embodiment may include monitoring available proxies, identifying a specific data session type and request, assigning a proxy best suited to the session and maintaining another data session via the VPN without a proxy. The process may also include monitoring, via a VPN server, data session characteristics of a plurality of proxy devices 332, identifying, via the VPN server, a proxy device among the plurality of proxy devices which is operating within a range of one or more threshold rates associated with data session characteristics 334, temporarily assigning, via the VPN server, the proxy device to a data session to provide data from a remote server to a client device 336, and providing another data session, via the VPN server, to the client device to another remote server 338. In one example, the VPN server assigns the proxy device to a first session for a client device to communicate with a remote server, then the VPN server assigns a second session of the client device to another remote server without using a proxy.

FIG. 3D illustrates a flow diagram of an example process of using a proxy device for data management according to example embodiments. Referring to FIG. 3D, another example may include receiving a request, at a client device, for data access from another client device 342, redirecting the request to a browser page on the client device 344, enabling data sharing via the browser page on the client device 346, and transmitting and receiving data via the client device to a remote server, and forwarding the received data to the another client device 348. The client device and the another client device may be communicating over a same Wi-Fi connection or communicating over different data connections.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

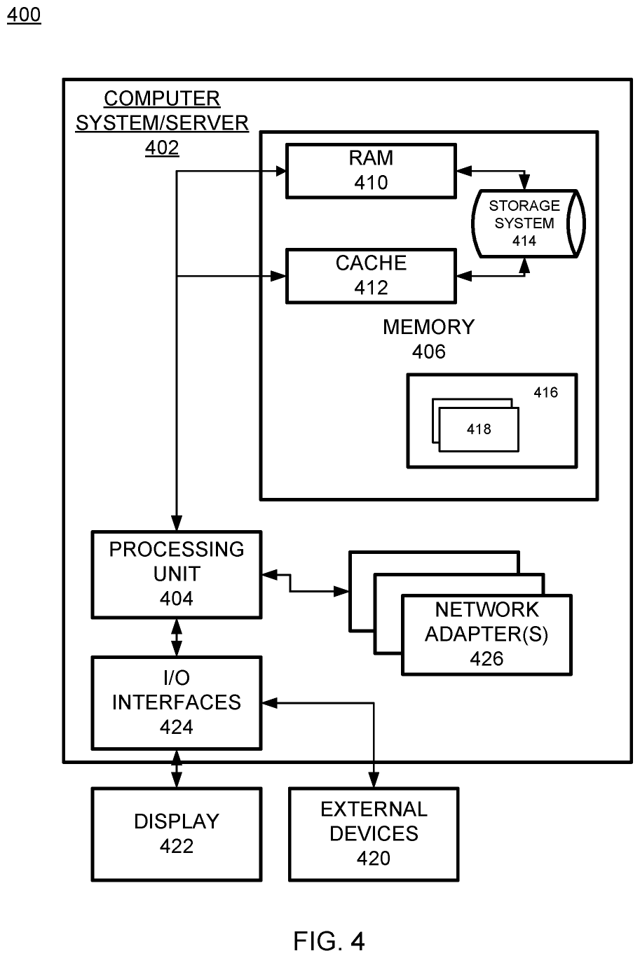

FIG. 4 illustrates an example network entity device configured to store instructions, software, and corresponding hardware for executing the same according to example embodiments. FIG. 4 is not intended to suggest any limitation as to the scope of use or functionality of embodiments of the application described herein. Regardless, the computing node 400 is capable of being implemented and/or performing any of the functionality set forth hereinabove.

In computing node 400 there is a computer system/server 402, which is operational with numerous other general purpose or special purpose computing system environments or configurations. Examples of well-known computing systems, environments, and/or configurations that may be suitable for use with computer system/server 402 include, but are not limited to, personal computer systems, server computer systems, thin clients, rich clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 402 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 402 may be practiced in distributed cloud computing environments where tasks are performed by remote processing devices that are linked through a communications network. In a distributed cloud computing environment, program modules may be located in both local and remote computer system storage media including memory storage devices.

As displayed in FIG. 4, computer system/server 402 in cloud computing node 400 is displayed in the form of a general-purpose computing device. The components of computer system/server 402 may include, but are not limited to, one or more processors or processing units 404, a system memory 406, and a bus that couples various system components including system memory 406 to processor 404.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 402 typically includes a variety of computer system readable media. Such media may be any available media that is accessible by computer system/server 402, and it includes both volatile and non-volatile media, removable and non-removable media. System memory 406, in one embodiment, implements the flow diagrams of the other figures. The system memory 406 can include computer system readable media in the form of volatile memory, such as random-access memory (RAM) 410 and/or cache memory 412. Computer system/server 402 may further include other removable/non-removable, volatile/non-volatile computer system storage media. By way of example only, storage system 414 can be provided for reading from and writing to a non-removable, non-volatile magnetic media (not displayed and typically called a “hard drive”). Although not displayed, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 406 may include at least one program product having a set (e.g., at least one) of program modules that are configured to carry out the functions of various embodiments of the application.

Program/utility 416, having a set (at least one) of program modules 418, may be stored in memory 406 by way of example, and not limitation, as well as an operating system, one or more application programs, other program modules, and program data. Each of the operating system, one or more application programs, other program modules, and program data or some combination thereof, may include an implementation of a networking environment. Program modules 418 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 402 may also communicate with one or more external devices 420 such as a keyboard, a pointing device, a display 422, etc.; one or more devices that enable a user to interact with computer system/server 402; and/or any devices (e.g., network card, modem, etc.) that enable computer system/server 402 to communicate with one or more other computing devices. Such communication can occur via I/O interfaces 424. Still yet, computer system/server 402 can communicate with one or more networks such as a local area network (LAN), a general wide area network (WAN), and/or a public network (e.g., the Internet) via network adapter(s) 426. As depicted, network adapter(s) 426 communicates with the other components of computer system/server 402 via a bus. It should be understood that although not displayed, other hardware and/or software components could be used in conjunction with computer system/server 402. Examples include, but are not limited to: microcode, device drivers, redundant processing units, external disk drive arrays, RAID systems, tape drives, and data archival storage systems, etc.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising
receiving a data session request at a VPN server from a client device to establish a data session to receive data from a remote server;
determining whether the data session request should be routed to one or more available proxy devices based on one or more of known attributes of the remote server and a data session requirement associated with the data session;
selecting by the VPN server, one or more proxy devices to forward the data request to the remote server, wherein the one or more proxy devices are selected based on one or more data session requirements associated with the data session;
receiving, at the VPN server, the data from the remote server by the one or more proxy devices; and
forwarding, via the VPN server, the data to the client device.

2. The method of claim 1, wherein the selecting the one or more proxy devices further comprises selecting the one or more proxy devices which are located closest to the remote server.

3. The method of claim 1, wherein the data session requirements comprise one or more of threshold rates comprising one or more of a data rate, a jitter rate and a latency rate.

4. The method of claim 3, comprising
monitoring, via the VPN, the one or more proxy devices for a period of time;
identifying a proxy device which is operating within an acceptable range of the one or more threshold rates; and
assigning the proxy device to the data session.

5. The method of claim 4, wherein the assigning the proxy device comprises assigning the proxy device to the data session for a limited period of time.

6. The method of claim 5, comprising
after the period of time, assigning a different proxy device to the data session.

7. The method of claim 1, comprising
detecting the data session has ended; and
assigning a different proxy device to a next data session request.

8. An apparatus comprising
a receiver configured to receive a data session request from a client device to establish a data session to receive data from a remote server;
a processor configured to
determine whether the data session request should be routed to one or more available proxy devices based on one or more of known attributes of the remote server and a data session requirement associated with the data session;
select one or more proxy devices to forward the data request to the remote server, wherein the one or more proxy devices are selected based on one or more data session requirements associated with the data session;
receive the data from the remote server by the one or more proxy devices; and
forward the data to the client device.

9. The apparatus of claim 8, wherein the selection of the one or more proxy devices further comprises the selection of the one or more proxy devices which are located closest to the remote server.

10. The apparatus of claim 8, wherein the data session requirements comprise one or more of threshold rates comprising one or more of a data rate, a jitter rate and a latency rate.

11. The apparatus of claim 10, wherein the processor is further configured to
monitor the one or more proxy devices for a period of time;
identify a proxy device which is operating within an acceptable range of the one or more threshold rates; and
assign the proxy device to the data session.

12. The apparatus of claim 11, wherein the proxy device being assigned comprises the proxy device being assigned to the data session for a limited period of time.

13. The apparatus of claim 12, wherein the processor also provides after the period of time assignment of a different proxy device to the data session.

14. The apparatus of claim 8, wherein the processor is further configured to
detect the data session has ended; and
assign a different proxy device to a next data session request.

15. A non-transitory computer readable storage medium configured to store instructions that when executed cause a processor to perform:
receiving a data session request at a VPN server from a client device to establish a data session to receive data from a remote server;
determining whether the data session request should be routed to one or more available proxy devices based on one or more of known attributes of the remote server and a data session requirement associated with the data session;
selecting by the VPN server, one or more proxy devices to forward the data request to the remote server, wherein the one or more proxy devices are selected based on one or more data session requirements associated with the data session;
receiving, at the VPN server, the data from the remote server by the one or more proxy devices; and
forwarding, via the VPN server, the data to the client device.

16. The non-transitory computer readable storage medium of claim 15, wherein the selecting the one or more proxy devices further comprises selecting the one or more proxy devices which are located closest to the remote server.

17. The non-transitory computer readable storage medium of claim 15, wherein the data session requirements comprise one or more of threshold rates comprising one or more of a data rate, a jitter rate and a latency rate.

18. The non-transitory computer readable storage medium of claim 17, wherein the processor is further configured to perform:
monitoring, via the VPN, the one or more proxy devices for a period of time;
identifying a proxy device which is operating within an acceptable range of the one or more threshold rates; and
assigning the proxy device to the data session.

19. The non-transitory computer readable storage medium of claim 18, wherein the assigning the proxy device comprises assigning the proxy device to the data session for a limited period of time.

20. The non-transitory computer readable storage medium of claim 19, wherein after the period of time, assigning a different proxy device to the data session.
